(19) United States
(12) Patent Application Publication
(10) Pub. No.: US 2014/0065298 A1
(43) Pub. Date: Mar. 6, 2014

(54) PRODUCTION METHOD FOR COATED ACTIVE MATERIAL

(71) Applicants: Kazumichi Yanagisawa, Kochi-shi (JP); Chenglong Yu, Kochi-shi (JP); Takumi Tanaka, Suntou-gun (JP)

(72) Inventors: Kazumichi Yanagisawa, Kochi-shi (JP); Chenglong Yu, Kochi-shi (JP); Takumi Tanaka, Suntou-gun (JP)

(73) Assignees: KOCHI UNIVERSITY, Kochi-shi, Kochi (JP); TOYOTA JIDOSHA KABUSHIKI KAISHA, Toyota-shi, Aichi-ken (JP)

(21) Appl. No.: 14/112,841

(22) PCT Filed: Apr. 12, 2012
(86) PCT No.: PCT/IB12/00725

§ 371 Date: Nov. 8, 2013

(30) Foreign Application Priority Data
Apr. 28, 2011 (JP) 2011-100867

(51) Int. Cl. H01M 4/04

(52) U.S. Cl. CPC H01M 4/0402
USPC 427/77

(57) ABSTRACT

A production method for a coated active material that is composed of an active material, and a coating layer of an oxide that covers the active material includes a preparation step of mixing an active material, an ingredient of an oxide, and water to prepare a mixture, and a hydrothermal treatment step of hydrothermally treating the mixture to form a coating layer.

### BACKGROUND OF THE INVENTION

1. Field of the Invention

The present invention relates to a production method for a coated active material by which a coated active material in which an active material is uniformly coated with a coating layer can be produced efficiently in a short period of time.

2. Description of Related Art

With the recent rapid spread of information and communication devices such as personal computers, video cameras and cellular phones, the development of batteries that are used as power sources for the devices is regarded as important. In the automotive industries, high-output and high-capacity batteries for electrical or hybrid vehicles are under development. Attention is currently focused on lithium batteries among various batteries because of their high energy density.

In the field of lithium battery, attempts are made to improve the performance of batteries, focusing on the interface between the active material and the electrolyte material. For example, International Publication No. 2007/004590 discloses that the surface of a positive-electrode active material for an all-solid lithium battery is coated with a lithium ion-conducting oxide to prevent the formation of a high-resistance layer at the interface between the positive-electrode active material and sulfide solid electrolyte.

As disclosed in International Publication No. 2007/004590, it is believed that the active material can be prevented from reacting with the electrolyte material when the surface of the active material is coated with a coating layer of a lithium ion-conducting oxide. However, a problem of the method of International Publication No. 2007/004590 is that because a uniform coating layer cannot be formed since the coating layer is formed by a tumbling fluidized bed coating method using a sol-gel solution, the reaction of the active material with the electrolyte material cannot be completely prevented. Another problem is that it takes a long time to form a coating layer by this method.

### SUMMARY OF THE INVENTION

The present invention provides a production method for a coated active material by which a coated active material in which an active material is coated with a coating layer can be produced efficiently in a short period of time.

An aspect of the present invention relates to a production method for a coated active material. The production method includes mixing an active material, an ingredient of an oxide, and water to prepare a mixture, and hydrothermally treating the mixture to coat the active material with a coating layer of the oxide.

According to the present invention, the formation of an oxide and precipitation of the oxide on the surface of the active material can be simultaneously accomplished by the hydrothermal treatment step, whereby a coated active material in which an active material is uniformly coated with a coating layer of an oxide can be obtained. In addition, because the hydrothermal reaction can be completed within, for example, one hour, the coating layer can be formed efficiently in a short period of time compared to a coating method using a sol-gel solution.

After the hydrothermal treatment step, a heat treatment may be performed on the coated active material. This is because when a heat treatment is performed on the coated active material after the hydrothermal treatment step, the strain in the crystal structure and the irregularity in grating spaces of the oxide that forms the coating layer can be removed.

The ingredient of the oxide may be at least one of hydroxides, oxides and metal salts. This is because the use of inexpensive ingredients leads to production cost-saving compared to a sol-gel method or dipping method in which an expensive metal alkoxide is used.

The present invention is effective in producing a coated active material by which a coated active material in which an active material is uniformly coated with a coating layer efficiently in a short period of time.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart that shows an example of the method for the production of a coated active material according to an embodiment of the present invention;

FIGS. 2A to 2D are explanatory views for comparing a coated active material according to the embodiment of the present invention and a coated active material according to a related art;

FIG. 3 is an X-ray diffraction (XRD) pattern of the coated active material of Example;

FIGS. 4A to 4D show results of a surface analysis on the coated active material of Example;

FIG. 5 shows a result of a surface analysis on the coated active material of Example;

FIG. 6 shows a result of a surface analysis on the coated active material of Comparative Example;

FIGS. 7A and 7B show results of a surface analysis on an active material before coating;

FIGS. 8A and 8B show results of a cross-sectional analysis on the coated active material of Example; and

FIG. 9 shows a result of a cross-sectional analysis on the coated active material of Example;

### DETAILED DESCRIPTION OF EMBODIMENTS

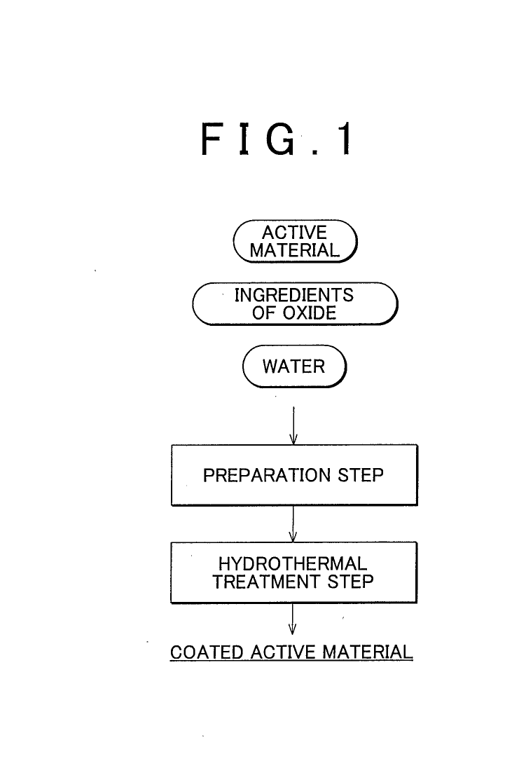

FIG. 1 is a flowchart that shows an example of the method for the production of a coated active material as an embodiment of the present invention. First, as shown in FIG. 1, an active material (for example, LiNi_{1/3}Co_{1/3}Mn_{1/3}O₂), ingredients of an oxide (for example, TiO₂ and LiOH.H₂O), and water (for example, pure water) are prepared and mixed to prepare a mixture (preparation step). Next, the mixture is poured into an autoclave, which is subsequently sealed tightly. Then, the mixture is subjected to a hydrothermal treatment at 200° C. for one hour, for example, with stirring in the autoclave to coat the active material with a coating layer of the oxide (hydrothermal treatment step). After that, the content of the autoclave is dried, and the recovered powder is subjected to a heat treatment at 600° C. for six hours in the ambient atmosphere, for example (heat treatment step). As a result, a coated active material that is composed of an active material and a coating layer of an oxide that covers the active material is obtained.

According to the embodiment of the present invention, the formation of an oxide and precipitation of the oxide on the surface of the active material can be simultaneously accomplished by the hydrothermal treatment step, whereby a coated active material in which an active material is coated with a coating layer of an oxide can be obtained. In addition, because the hydrothermal reaction can be completed within, for example, one hour, the coating layer can be formed efficiently in a short period of time compared to a coating method using a sol-gel solution. Because the coated active material that is produced by the above method has a coating layer of an oxide, the coating layer will be present between the active material and other substances with which the coated active material may come into contact (for example, an electrolyte material such as solid electrolyte material, electrolytic solution or polymer electrolyte material). Thus, because the active material is prevented from reacting with other substances, an increase in interface resistance is prevented. The coated active material of the present invention can be used not only in solid-state batteries but also in liquid-type batteries and polymer-type batteries.

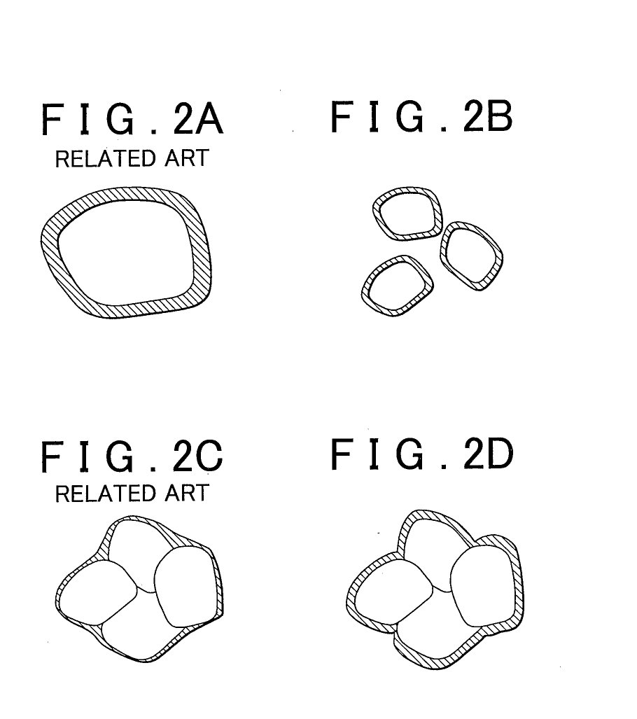

By a coating method using a sol-gel solution, an active material with a large particle size as exemplified in FIG. 2A can be coated, but a fine active material (2 μm or smaller) or an irregularly-shaped active material (such as agglomerated particles) as exemplified in FIG. 2C cannot be uniformly coated. On the contrary, because the above production method uses a hydrothermal treatment in which the mixture is heated under increased pressure, a uniform coating layer can be formed on a fine active material (2 μm or smaller) as exemplified in FIG. 2B and an irregularly-shaped active material as exemplified in FIG. 2D. Description is made of the steps of the method for the production of a coated active material according to the embodiment of the present invention one by one below.

1. Preparation Step

The preparation step in the embodiment of the present invention is first described. The preparation step is a step of mixing an active material, ingredients of an oxide, and water to prepare a mixture.

The active material suitable for use in the present invention differs depending on the type of the conducting ions in the battery in which the target coated active material is used. For example, when the coated active material is used in a lithium secondary battery, the active material absorbs and releases Li ions.

Examples of the active material suitable for use in the present invention include, but is not specifically limited to, oxide active materials. This is because a high capacity can be expected. Examples of oxide active materials suitable for use as a positive-electrode active material in lithium batteries include an oxide active material that is represented by a general formula LiₓM_{y}O_{z} (wherein M represents a transition metal element, and x=0.02 to 2.2, y=1 to 2 and z=1.4 to 4). In the general formula, M is preferably at least one selected from the group which consists of Co, Mn, Ni, V and Fe, more preferably at least one selected from the group which consists of Co, Ni and Mn. Specific examples of the oxide active material include bedded salt-type active materials such as LiCoO₂, LiMnO₂, LiNiO₂, LiVO₂ and LiNiₓCo_{y}Mn_{z}O₂ (0≦x, y, z≦1, except x=y=z=0), and spinel-type active materials such as LiMn₂O₄ and Li(Ni_{0.5}Mn_{1.5})O₄. Examples of oxide active materials other than the compound that is represented by the above general formula LiₓM_{y}O_{z} include olivine-type active materials such as LiFePO₄, LiMnPO₄ and LiCoPO₄, and Si-containing active materials such as Li₂FeSiO₄ and Li₂MnSiO₄.

Examples of oxide active materials suitable for use as a negative-electrode active material in lithium batteries include Nb₂O₅, Li₄Ti₅O₁₂ and SiO. The active material in the present invention may be used either as a positive-electrode active material or as a negative-electrode active material. This is because it depends on the potential between the active material and the other active material with which the active material is combined whether it serves as a positive-electrode active material or a negative-electrode active material.

Examples of the form of the active material include particles. Preferably, the active material is in the form of perfectly spherical particles or oval-spherical particles. When the active material is in the form of particles, the particles preferably has an average particle size (D₅₀) in the range of, for example, 0.1 μm to 50 μm.

The content of the active material in the mixture in the present invention is suitably selected based on the target coated active material.

The ingredients of the oxide suitable for use in the present invention is not specifically limited as long as the oxide can be formed and uniformly precipitated on the surface of the active material in the hydrothermal treatment step, which is described later. In the present invention, an oxide synthesized in advance may be used as an ingredient of the oxide. Examples of the oxide suitable to form the coating layer of the coated active material of the present invention include a lithium-containing oxide that is represented by a general formula LiₓAO_{y} (wherein A represents at least one selected from the group which consists of B, C, Al, Si, P, S, Ti, Zr, Nb, Mo, Ta and W, and x and y each represents a positive number). Specific examples include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄ and Li₂WO₄. Above all, in the present invention, the lithium-containing oxide is preferably Li₂TiO₃, Li₂SiO₃, Li₃PO₄, Li₄Ti₅O₁₂ or Li₂Ti₂O₅. When the active material is Li₄Ti₅O₁₂, an oxide that is more stable than Li₄Ti₅O₁₂ is used as the oxide for the coating layer.

The ingredients of the oxide suitable for use in the present invention are not specifically limited as long as the oxide as described above can be formed. Specific examples include hydroxides, oxides, metal salts, metal alkoxides and metal complexes. Above all, in the present invention, the ingredients of the oxide are at least one selected from the group which consists of hydroxides, oxides and metal salts. This is because the use of inexpensive ingredients leads to production cost-saving compared to a sol-gel method or dipping method in which an expensive metal alkoxide is used.

Among the ingredients of the oxide, a hydroxide, such as LiOH or LiOH.H₂O, or an oxide, such as Li₂O or Li₂O₂, is used as an Li source when the component A in the lithium-containing oxide is a metal, and a metal oxide, metal salt or metal complex that contains the component A is used as a source of the component A. For example, when the lithium-containing oxide is Li₂TiO₃, LiOH.H₂O or LiOH as a Li source and anatase-type TiO₂ as a Ti source may be used as the ingredients of the oxide. When the component A in the lithium-containing oxide is a non-metal, the lithium-containing oxide can be used as it is as the ingredient of the oxide. For example, when the lithium-containing oxide is Li₂CO₃, Li₂CO₃ may be used as the ingredient of the oxide. When the component A in the lithium-containing oxide is B (boron), and Li source as described above and boric acid as a B-source can be used as the ingredients of the oxide. The O-source for the lithium-containing oxide may be derived either from the ingredients of the oxide or from water that is contained in the mixture in the present invention.

The content of the ingredients of the oxide in the mixture in the present invention is suitably selected based on the target coated active material.

The water suitable for use in the present invention is not specifically limited as long as it does not react with the active material and the ingredients of the oxide. Specific examples include pure water and distilled water. The mixture in the present invention may also contain additives, such as a pH adjuster (e.g., NH₄OH, HCl or HNO₃), as needed. The method for the preparation of the mixture is not specifically limited as long as the active material and the ingredients of the oxide can be dissolved or highly dispersed in the water as a solvent.

2. Hydrothermal Treatment Step

The hydrothermal treatment step in the embodiment of the present invention is next described. The hydrothermal treatment step in the present invention is a step of hydrothermally treating the mixture to form a coating layer of the oxide on the active material.

The hydrothermal treatment in this step is a process of heating the mixture under increased pressure to induce a hydrothermal reaction. Because the hydrothermal reaction proceeds through a dissolution-precipitation mechanism, the oxide can be precipitated to form a uniform coating layer with a desired thickness on the surface of the active material by adjusting the amount and solubility of the oxide to be formed. In addition, because a dissolution-precipitation reaction proceeds quickly in a hydrothermal reaction, the coating layer can be formed in a shorter time than can be formed by a coating method using a sol-gel solution.

The thickness of the coating layer that is formed in this step is not specifically limited as long as the coating layer is thick enough to prevent the active material from reacting with other substances (for example, an electrolyte material such as solid electrolyte material, electrolytic solution or polymer electrolyte material), and is suitably selected based on the target coated active material. For example, the thickness is preferably in the range of 1 nm to 500 nm, more preferably in the range of 2 nm to 100 nm, much more preferably in the range of 3 nm to 50 nm. This is because the active material may react with other substances when the coating layer is too thin, and the ion conductivity may decrease when the coating layer is too thick. The thickness of the coating layer can be determined by observation under a transmission electron microscope (TEM). The coverage of the coating layer on the surface of the active material is preferably as high as possible from the viewpoint of the prevention of an increase in interface resistance. Specifically, the coverage is preferably 50% or higher, more preferably 80% or higher. The coating layer may cover the entire surface of the active material. The coverage of the coating layer can be determined by observation under a transmission electron microscope (TEM).

The hydrothermal treatment temperature in this step is not specifically limited as long as a coating layer of the oxide can be formed on the active material. For example, the temperature is preferably in the range of 150° C. to 250° C., more preferably in the range of 180° C. to 230° C. The hydrothermal treatment time in this step is preferably in the range of 10 minutes to 30 hours, for example.

In addition, this step is carried out in a reactor which can resist high temperature and high pressure, such as an autoclave. At this time, the air in the autoclave may be substituted by an inert gas, such as nitrogen, to prevent deterioration of the coated active material.

3. Additional Steps

The method for the production of a coated active material according to the embodiment of the present invention, which at least has the preparation step and the hydrothermal treatment step as described above, may include additional steps as needed. Examples of the additional steps include drying step and heat treatment step. Especially, the method preferably include a heat treatment step in which the coated active material is subjected to a heat treatment after the hydrothermal treatment step. This is because when a heat treatment is performed on the coated active material after the hydrothermal treatment step, the strain in the crystal structure and the irregularity in grating spaces of the oxide that forms the coating layer can be removed, resulting in an increased Li ion conductivity. For example, when the oxide that forms the coating layer is Li₂TiO₃, the Li₂TiO₃ has a layered structure and the layers are not parallel but randomly oriented in the crystal structure even after the hydrothermal treatment. However, when a heat treatment is carried out, the layers can be oriented parallel to each other to form an almost perfect crystal structure without strains.

The heat treatment temperature in the heat treatment step is not specifically limited as long as a target coated active material can be obtained. For example, the temperature is preferably in the range of 400° C. to 1000° C., more preferably in the range of 500° C. to 700° C. This is because a large amount of impurities may remain when the heat treatment temperature is too low, and a target coated active material may not be obtained when the heat treatment temperature is too high. The heat treatment time in the heat treatment step is preferably in the range of one hour to 20 hours, for example.

The heat treatment atmosphere in the heat treatment step is not specifically limited as long as it does not deteriorate the coated active material. Examples of the atmosphere include an ambient air atmosphere, an inert gas atmosphere such as nitrogen atmosphere or argon atmosphere, and vacuum. Examples of the heat treatment method for the coated active material include a method using a baking furnace.

4. Coated Active Material

Examples of the usage of the coated active material of the present invention include the use in batteries, such as solid-state batteries and non-aqueous electrolyte batteries. Especially, the use in solid-state batteries is preferred. This is because a solid-state battery with excellent charge-discharge characteristics and high durability can be achieved since an increase in interface resistance can be prevented by preventing a reaction of the active material with a solid electrolyte material, such as a sulfide solid electrolyte material.

It should be noted that the present invention is not limited to the above embodiment. The above embodiment is shown for illustrative purpose only.

The following examples describe the embodiment of the present invention in more detail.

### Example

### Production of Coated Active Material

First, 37.6 g of a LiNi_{1/3}Co_{1/3}Mn_{1/3}O₂ powder as an active material, 1.03 g of an anatase-type TiO₂ powder (manufactured by Wako Pure Chemical Industries, Ltd.) and 1.08 g of an LiOH.H₂O powder (manufactured by Wako Pure Chemical Industries, Ltd.) as ingredients of an oxide, and 12.9 mL of pure water were mixed to prepare a mixture. In this case, the mixture contained Li₂TiO₃ in an amount of 5% by volume of the total volume of LiNi_{1/3}Co_{1/3}Mn_{1/3}O₂ and Li₂TiO₃ with a LiOH.H₂O concentration of 2 mol/L and the moles of TiO₂ being half the moles of LiOH.H₂O. Then, the mixture was poured into a Teflon (trademark) lined autoclave, and the autoclave was tightly sealed. The mixture was held at 200° C. for one hour with stirring in the autoclave to carry out a hydrothermal treatment. After that, the content of the autoclave (coated active material) was dried. The recovered coated active material powder was placed in an alumina vessel, and was subjected to a heat treatment at 600° C. for six hours in a muffle furnace in the ambient atmosphere. As a result, a coated active material (LiNi_{1/3}Co_{1/3}Mn_{1/3}O₂ that was coated with a coating layer of Li₂TiO₃) was obtained.

(Synthesis of Sulfide Solid Electrolyte Material)

As starting materials, lithium sulfide (Li₂S) and diphosphorus pentasulfide (P₂S₅) were used. The powders of the starting materials were weighed in an Ar atmosphere (dew point: −70° C.) in a glove box to obtain a molar ratio of Li₂S:P₂S₅=75:25, and mixed in an agate mortar to obtain a raw material composition. Then, 2 g of the obtained raw material composition was placed in a 45 ml zirconia pot. Four grams of dehydrated heptane (water content: 30 ppm or less) and zirconia balls (F 5 mm, 53 g) were also added to the pot, and the pot was completely sealed (Ar atmosphere). The pot was mounted on a planetary ball mill (P7, manufactured by Fritsch), and a mechanical milling cycle that consisted of one-hour processing followed by 15-minute standing was carried out 40 times at a table-rotation speed of 500 rpm. After that, the obtained sample was dried on a hot plate that was set at 100° C. to remove heptane, thereby obtaining a sulfide solid electrolyte material (75Li₂S-25P₂S₅).

(Production of Battery for Evaluation)

A power generation element that has a positive-electrode active material layer/solid electrolyte layer/negative-electrode active material layer structure was produced using a pressing machine. A positive electrode mixture that was obtained by mixing the above coated active material and 75Li₂S-25P₂S₅ at a volume ratio of 50:50 was used as a material of the positive-electrode active material layer, a negative electrode mixture that was obtained by mixing natural graphite and 75Li₂S-25P₂S₅ at a volume ratio of 50:50 was used as a material of the negative-electrode active material layer, and 75Li₂S-25P₂S₅ was used as a material of the solid electrolyte layer. A battery for evaluation was produced using the power generation element.

### Comparative Example

A battery for evaluation was obtained in the same manner as in Example except that a coated active material was produced as described below.

(Production of Coated Active Material)

First, ethoxylithium (LiOC₂H₅) and pentaethoxyniobium (Nb(OC₂H₅)₅) were mixed at a molar ratio of Li:Nb=1:1 in ethanol to prepare a coating solution. Next, the coating solution was applied to an active material (LiNi_{1/3}Co_{1/3}Mn_{1/3}O₂) at a rate of 1 nm/h for 30 hours with a coating device using a tumbling fluidized bed coating method and dried with hot air. Then, the LiNi_{1/3}CO_{1/3}Mn_{1/3}O₂ powder, which had been coated with the coating solution, was subjected to a heat treatment at 350° C. for five hours in the ambient atmosphere. As a result, a coated active material (LiNi_{1/3}Co_{1/3}Mn_{1/3}O₂ that was coated with a coating layer of LiNbO₃) was obtained.

[Evaluation] X-Ray Diffraction Measurement

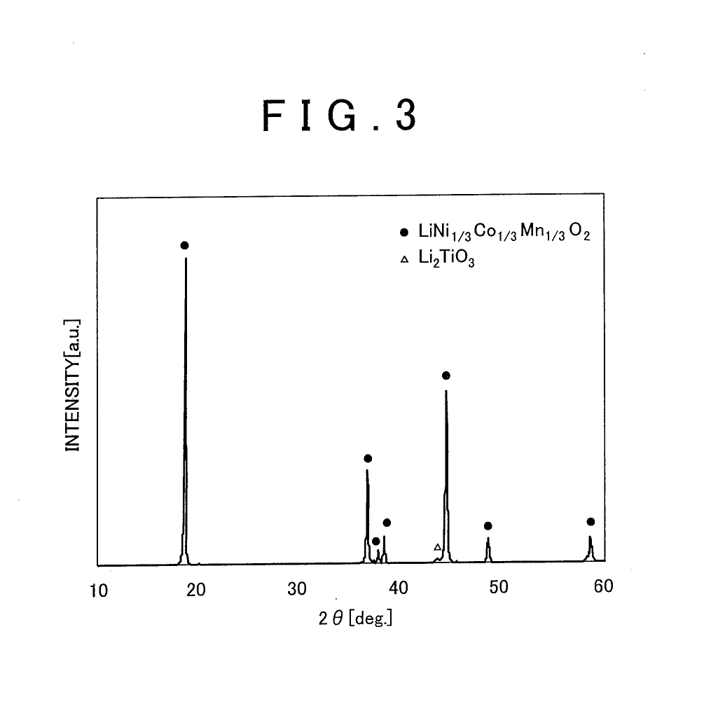

X-ray diffraction (XRD) measurement of the coated active material of Example was conducted. The result is shown in FIG. 3. As shown in FIG. 3, only peaks of Li₂TiO₃ and LiNi_{1/3}CO_{1/3}Mn_{1/3}O₂ were observed. This proves that the coated active material of Example was composed only of an active material (LiNi_{1i/3}CO_{1/3}Mn_{1/3}O₂) and Li₂TiO₃.

(Surface Analysis of Coated Active Material)

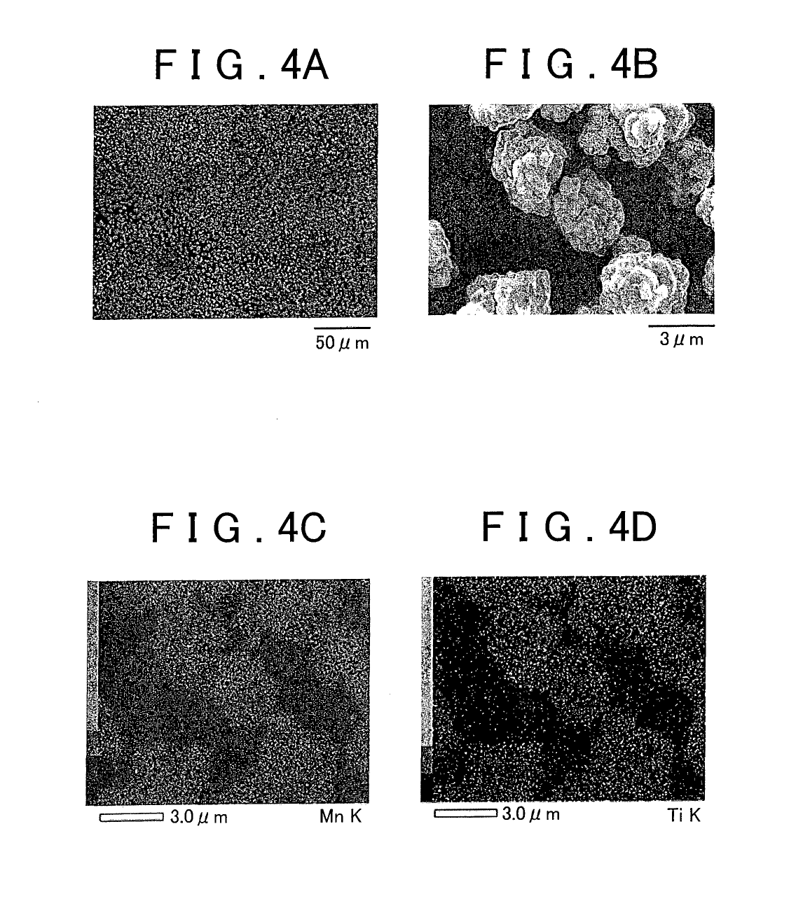

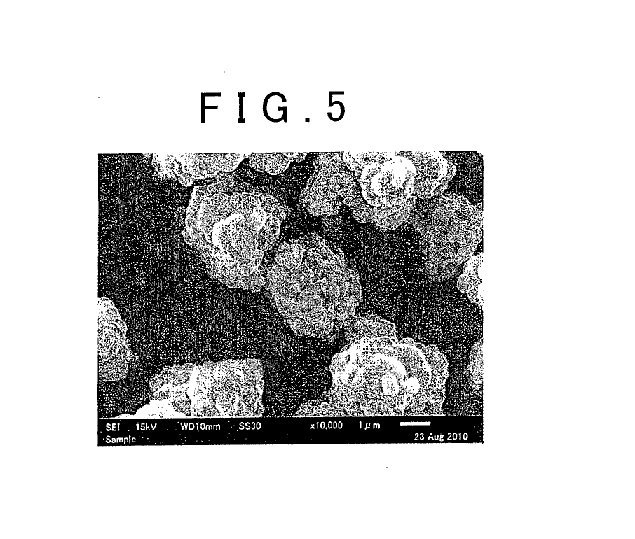

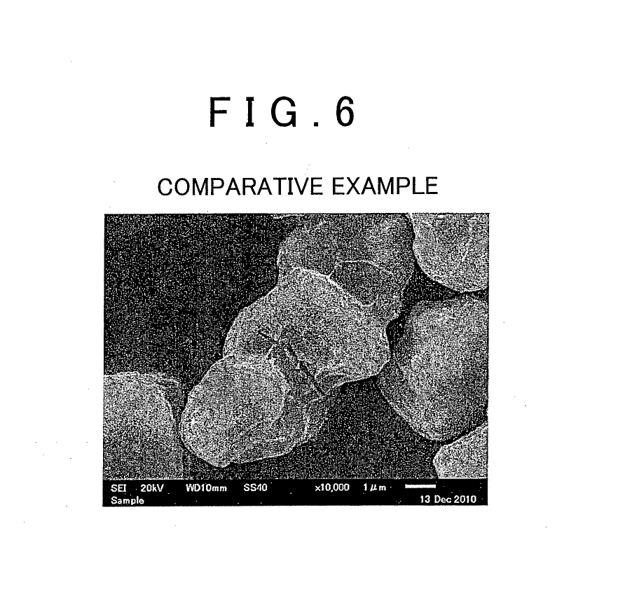

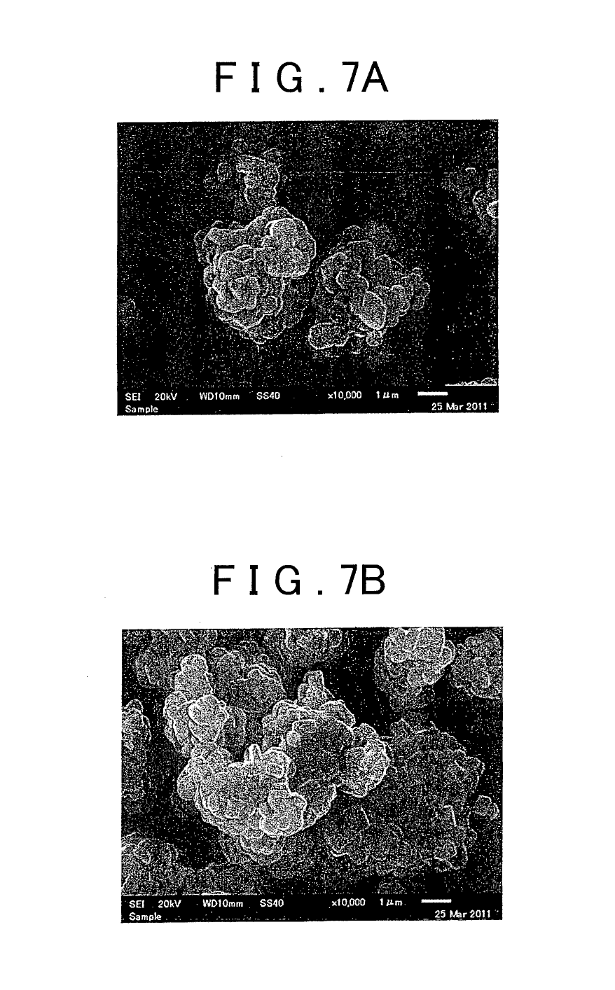

A surface analysis of the coated active materials of Example and Comparative Example and the active material before coating was conducted using a scanning electron microscope (SEM-EDX). The results are shown in FIG. 4A to FIG. 7B. FIGS. 4A and 4B show SEM images of the coated active material of Example, and FIGS. 4C and 4D show results of EDX elemental mapping for Mn and Ti, respectively, in the same region that is shown in FIG. 4B. FIG. 5 shows an SEM image of the coated active material of Example, FIG. 6 shows an SEM image of the coated active material of Comparative Example, and FIGS. 7A and 7B show SEM images of the active material before coating. No liberated Li₂TiO₃ was observed in the coated active material of Example as shown in FIGS. 4A to 4D, and the result of elemental mapping proved that Mn, which is a constituent element of the active material, and Ti, which is a constituent element of Li₂TiO₃, were present in the same particles. In addition, comparison of FIG. 5 and FIGS. 7A and 7B proved that fine agglomerated particles of the active material were uniformly coated in the coated active material of Example. On the contrary, it was proved that the coating layer covered the active material non-uniformly, filling the irregularities in the surface thereof, in the coated active material of Comparative Example as shown in FIG. 6.

(Cross-Sectional Analysis of Coated Active Material)

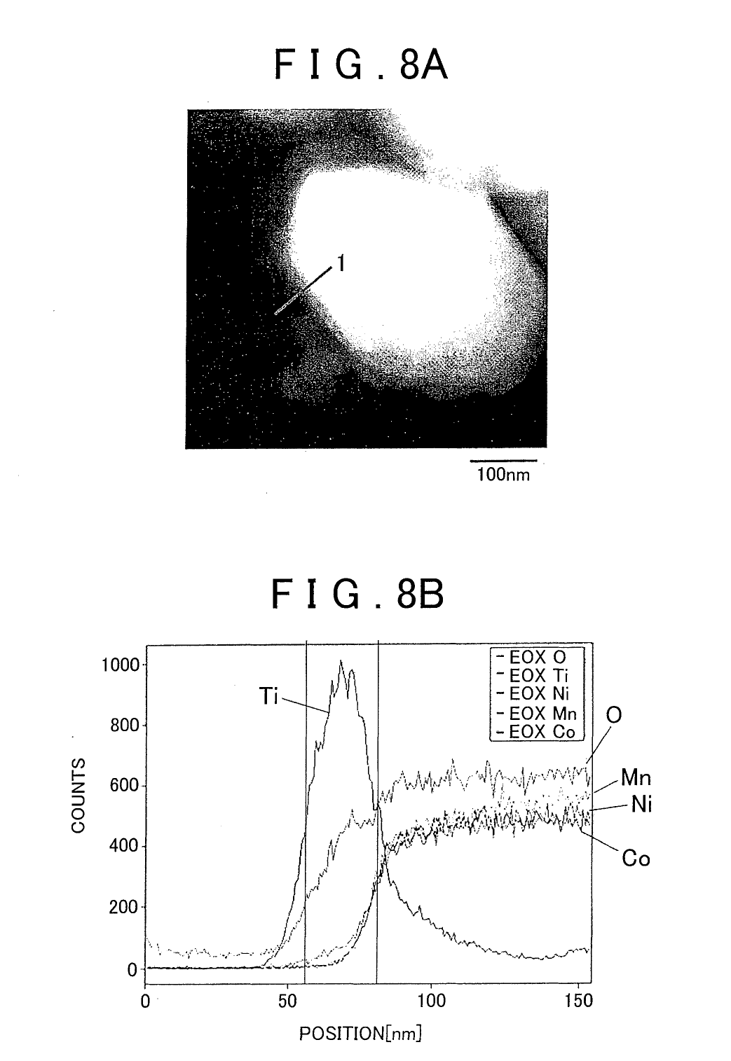

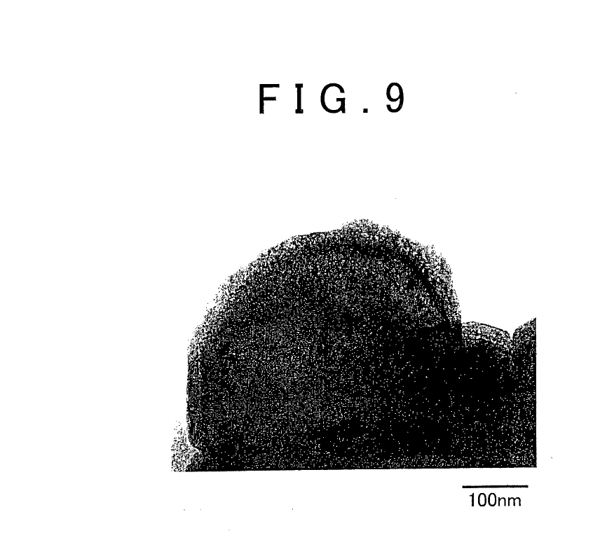

A cross-sectional analysis of the coated active material of Example was conducted using a transmission electron microscope (TEM-EDX). The result is shown in FIGS. 8A and 8B and FIG. 9. FIG. 8A shows an STEM image of a cross-section of a primary particle of the coated active material, FIG. 8B shows a result of an EDX elemental line analysis along a line 1 in FIG. 8A, and FIG. 9 shows a TEM image of a cross-section of an agglomerated particle of the coated active material. As shown in FIGS. 8A and 8B, it was proved that a fine active material particle with a diameter of approximately 500 nm was uniformly coated with a Ti-containing coating layer with a thickness of approximately 30 nm. Combined with the result of XRD measurement that is described above, it is believed that the coating layer consists of Li₂TiO₃. In addition, it was proved that even irregularly-shaped agglomerated particles were coated with Li₂TiO₃ remarkably uniformly as shown in FIG. 9. On the contrary, in Comparative Example, coating was not formed when a fine active material with a diameter of approximately 500 nm was used because the active material particles were agglomerated and lost fluidity necessary for the tumbling fluidized bed coating method, and a non-uniform coating layer was formed filling the irregularities in the surface of the active material when irregularly-shaped active material with a diameter of approximately 3 μm was used. It can be appreciated from the above results that the hydrothermal treatment induces the efficient formation of a coated active material that is composed of an active material which is uniformly coated with a coating layer in a short period of time in the method for the production of a coated active material according to the present invention.

(Evaluation of Rate of Increase in Resistance)

The batteries for evaluation that were obtained in Example and Comparative Example were evaluated as to the rate of increase in resistance. Specifically, first, the resistance was measured by an AC impedance method with the battery for evaluation charged to 4.1 V. The measurement conditions were: frequency of 0.1 Hz to 1 MHz, superposition of AC voltage with an amplitude of 10 mV, and environmental temperature of 25° C. Then, the semicircle in the direction of the real number axis of the semicircle on the low-frequency side that appeared in the complex impedance plots was regarded as a resistance component derived from a positive electrode interfacial reaction, and the rate of increase from the initial value was obtained after storage at 60° C. in a thermostat oven (10 days). The result is summarized in Table 1.

TABLE 1

| | | | | Rate of |
|---|---|---|---|---|
| | | Coating | Formation | increase in |
| | Active material | layer | method | resistance |
| Example | LiNi_{1/3}Co_{1/3}Mn_{1/3}O₂ | Li₂TiO₃ | Hydrothermal | 1.30 |
| | | | treatment | |
| Comp. | LiNi_{1/3}Co_{1/3}Mn_{1/3}O₂ | LiNbO₃ | Sol-gel method | 1.42 |
| Example | | | | |

As shown in Table 1, the rate of increase in resistance in the battery for evaluation of Example was smaller than that in the battery for evaluation of Comparative Example. This is believed to be because a reaction of the active material with the sulfide solid electrolyte material was able to be prevented because a coating layer of Li₂TiO₃ was uniformly formed on the surface of the active material by the hydrothermal treatment.

1. A production method for a coated active material, comprising:
mixing an active material, an ingredient of an oxide, and water to prepare a mixture, and
hydrothermally treating the mixture under an increased pressure to coat the active material with a coating layer of the oxide, wherein the active material is represented by a compound of a general formula LiMyOz, wherein M represents a transition metal element, and x=0.02 to 2.2, y=1 to 2 and z=1.4 to 4; and the ingredient of the oxide is represented by a compound of a general formula LixAOy, wherein A consists of an element selected from the group consisting of B, C, Al, Si, P, S, Ti, Zr, Nb, Mo, Ta, and W; and x and y each represent a positive number.

2. The production method according to claim 1, further comprising: performing a heat treatment on the coated active material after the mixture is hydrothermally treated.

3. The production method according to claim 1, wherein the ingredient of the oxide is at least one of hydroxides, oxides and metal salts.

4. The production method according to claim 1, wherein the active material is an electrode active material for a battery.

5. The production method according to claim 4, wherein the battery is a lithium secondary battery.
